(19) United States
(12) Patent Application Publication
(10) Pub. No.: US 2024/0058877 A1
(43) Pub. Date: Feb. 22, 2024

(54) CUTTING EQUIPMENT FOR METAL STRIP

(71) Applicant: DONGGUAN SIBEIFU INTELLIGENT TECHNOLOGY CO., LTD., Dongguan (CN)

(72) Inventor: Qi Lu, Dongguan (CN)

(21) Appl. No.: 18/498,521

(22) Filed: Oct. 31, 2023

(30) Foreign Application Priority Data
Dec. 14, 2022 (CN) 202211611949.6

(51) Int. Cl. B23D 33/08; B23D 33/02

(52) U.S. Cl. CPC B23D 33/08; B23D 33/02

(57) ABSTRACT

Cutting equipment for a metal strip includes a frame, and a feeding device, a fetching device and a cutting device. The cutting device includes a first pressing mechanism, a support platform, and a vacuum generating device, the first pressing mechanism is configured to press the strip, the support platform is provided with a through hole connected to the vacuum generating device. The vacuum generating device is configured to position the strip on the support platform, the first pressing mechanism and the support platform are movable up and down respectively to form a height difference between a first strip section located on the first pressing mechanism and a second strip section located on the support platform for cutting. The equipment can automatically cut metal strips, and is more reliable in the cutting operation and has a high cutting success rate.

### FIELD OF THE INVENTION

The invention relates to the field of automated equipment, in particular to cutting equipment for a metal strip with compact structure.

### BACKGROUND OF THE INVENTION

At present, in the industrial manufacturing sector, it is often necessary to cut metal strips to obtain sheet materials. For example, in the semiconductor industry, surface mount technology requires the use of tin sheets for soldering, which need to be cut from tin strips. Therefore, there is a need for corresponding cutting equipment to cut the metal strip materials into sheet materials. Currently, the cutting equipment primarily involves placing the strip material onto two cutting blades and pressing the material onto the blades using a pressing mechanism from above. The two cutting blades form a height difference to cut the strip material. However, the reliability of pressing the strip material onto the cutting blades using the pressing mechanism is not guaranteed. It is possible to cause failed cutting if the contact between the pressing mechanism and the strip material is not in place. Moreover, the presence of the pressing mechanism adds complexity to the mechanical structure, and the prolonged use may lead to equipment failure due to wear and tear.

Therefore, it is necessary to provide cutting equipment for a metal strip with compact structure that can solve the aforementioned problems.

### SUMMARY OF THE INVENTION

The objective of the invention is to provide cutting equipment for a metal strip, which can automatically cut metal strips, and is more reliable in the cutting operation and has a high cutting success rate.

To achieve the above objective, the invention provides cutting equipment for a metal strip, including a frame, and a feeding device, a fetching device and a cutting device mounted on the frame respectively; wherein the feeding device is configured to providing a strip; the fetching device is configured to press the strip pulled from the feeding device and convey the strip to the cutting device; and the cutting device includes a first pressing mechanism, a support platform, and a vacuum generating device, the first pressing mechanism is configured to press the strip, the support platform is provided with a through hole which is connected to the vacuum generating device; when the through hole is covered by the strip, the vacuum generating device is configured to extract air in the through hole so as to position the strip on the support platform, the first pressing mechanism and the support platform are movable up and down respectively to form a height difference between a first strip section located on the first pressing mechanism and a second strip section located on the support platform for cutting.

As an embodiment, the fetching device includes a second pressing mechanism and a first moving mechanism, the second pressing mechanism is provided with a pressing channel, the pressing channel includes a first pressing surface and a second pressing surface which are mutually parallel, when the strip pulled from the feeding device is located in the pressing channel, the second pressing mechanism is configured to close the pressing channel to bring the first pressing surface close to the second pressing surface so as to press the strip, and the first moving mechanism is configured to drive the second pressing mechanism to move the strip pressed to the cutting device.

As an embodiment, the second pressing mechanism includes a first pressing module and a second pressing module, the first pressing module includes a first supporting member and a pressing member connected to the first supporting member, the pressing member is slidably connected to the second pressing module, the second pressing module is connected to the first moving mechanism, the pressing member is oppositely arranged with the second pressing module to form the pressing channel, the fetching device further includes a second moving mechanism which is configured to drive the first supporting member to move up and down, under an action of an upward and downward movement of the first supporting member, the pressing member moves close or away from the second pressing module to close or open the pressing channel.

As an embodiment, the cutting device further includes a second supporting member and a third moving mechanism connected to the second supporting member, the second supporting member is slidably connected to the frame, the first pressing mechanism includes a third pressing module and a fourth pressing module arranged opposite to each other, the fourth pressing module is movably connected to the second supporting member, a first elastic member is provided between a bottom of the fourth pressing module and the second supporting member, and the support platform is connected to the second supporting member.

As an embodiment, the third moving mechanism is configured to drive the second supporting member to move up and down to bring the fourth pressing module close to or away from the third pressing module to press or release a strip section located between the third pressing module and the fourth pressing module.

As an embodiment, during an upward movement of the third supporting member, the third pressing module is configured to block the fourth pressing module and compress the first elastic member, and another strip section positioned by the through hole and the vacuum generating device on the support platform continues to be lifted for cutting under a driving of the third supporting member.

As an embodiment, the cutting equipment further includes a driving device, wherein the driving device includes a first cam, the first moving mechanism includes a second elastic member, a first sliding structure, and a first transmission structure, the second pressing mechanism is be movably arranged in the frame through the first sliding structure, two ends of the second elastic member are respectively connected to the first transmission structure and the frame to make the first transmission structure tend to move away from the cutting device, the first transmission structure includes a first movable member, the first movable member is provided with a first sliding part, the first movable member is connected to the second pressing mechanism, the first sliding part abuts against the first cam, the driving device is configured to drive the first cam to rotate, under a rotation of the first cam, the first sliding part slides along the first cam to make the second pressing mechanism laterally slide to close or move away from the cutting device.

As an embodiment, the second moving mechanism includes a second transmission structure and a second sliding structure, the second transmission structure includes a second movable member, and the second movable member is provided with a second sliding part and a third sliding part, and the second sliding structure is arranged between the second pressing module and the pressing member, and the pressing member is slidably connected to the second pressing module up and down through the second sliding structure.

As an embodiment, the second movable member is connected to a bottom of the first supporting member through the first sliding structure, and the driving device includes a limit groove and a second cam, the second sliding part is located in the limit groove, and the third sliding part abuts against an outer peripheral wall of the second cam; when the second cam is driven to rotate, the third sliding part slides along the outer peripheral wall of the second cam to drive the second movable member, the first supporting member, and the pressing member to move up and down.

As an embodiment, the third moving mechanism includes a fourth sliding part and a third sliding structure provided on the second supporting member, the second supporting member is slidably connected to the frame up and down through the third sliding structure, the driving device includes a third cam, and the fourth sliding part abuts against an outer peripheral wall of the third cam; when the third cam is driven to rotate, the fourth sliding part slides along the outer peripheral wall of the third cam to drive the second supporting member to move up and down.

As an embodiment, the driving device includes a drive motor, a rotating shaft connected to an output end of the drive motor, and a first cam, a second cam and a third cam respectively provided on the rotating shaft, and the limit groove is provided on the rotating shaft.

As an embodiment, an edge of a surface of the first cam includes a first portion and a second portion protruding from the surface; the outer peripheral wall of the second cam includes a third portion and a fourth portion, and a distance between the third portion and a rotation center of the second cam is smaller than a distance between the fourth portion and the rotation center of the second cam; the outer peripheral wall of the third cam includes a fifth portion and a sixth portion, and a distance between the fifth portion and a rotation center of the third cam is smaller than a distance between the sixth portion and the rotation center of the third cam.

As an embodiment, when the first sliding part abuts against the first portion, the third sliding part abuts against the fourth portion, and the fourth sliding part abuts against the sixth portion, the second pressing mechanism is in a first position away from the cutting device, and the pressing channel is in an open state, and the first pressing mechanism is configured to press the strip; when the driving motor drives the second cam and the third cam to rotate, the third sliding part slides to the third portion, and the fourth sliding part slides to the fifth portion, the pressing channel is in a closed state, and the first pressing mechanism is configured to release the strip; the driving motor continues to drive the first cam to rotate, causing the first sliding part to slide to the second portion, the second pressing mechanism moves to a second position close to the cutting device, and the vacuum generation device is configured to extract the air in the through hole so as to position the strip section on the support platform; the driving motor continues to drive the third cam to rotate, causing the fourth sliding part to slide from the fifth portion to the sixth portion, and the first pressing mechanism is configured to press the strip to form a height difference with the support platform for cutting.

As an embodiment, the cutting equipment further includes a length adjustment device, wherein the length adjustment device includes a fixing member, a threaded pillar, and an adjusting nut, the fixing member is connected to the first movable member, the threaded pillar includes a threaded portion, the adjusting nut is screwed into the threaded portion, the threaded pillar is located inside a side wall of the frame and one end of the threaded pillar faces the fixing member, the side wall of the frame corresponding to a position of the adjusting nut is provided with an opening, the adjusting nut is rotatable to adjust a length of the threaded pillar between the adjusting nut and the fixing member; under a pulling action of the second elastic member, the threaded pillar is configured to block the fixing member to prevent the first movable member from moving further away from the cutting device.

As an embodiment, the feeding device includes a connecting member, a reel rotatably connected to the connecting member, and a braking structure, the connecting member is connected to the frame, the reel is wound with the strip to be cut, and the braking structure includes a rotating shaft, a braking member, and a braking elastic member, the braking elastic member is connected to the braking member, the braking member is rotatably connected to the connecting member through the rotating shaft, the braking elastic member is configured to apply a force to one end of the braking member to rotate around the rotating shaft, and another end of the braking member abuts against the reel, and the reel is configured to limit a rotation tendency of the braking member.

Based on the above structures and configurations, the present invention enables automated cutting of the strips and simplifies the mechanical structure of the device by using the vacuum generating device and the through hole instead of traditional pressing mechanisms. Meanwhile, the reliability of the cutting operation is improved to prevent the prolonged wear of the pressing mechanism from affecting the cutting effect.

### BRIEF DESCRIPTION OF THE DRAWINGS

The accompanying drawings facilitate an understanding of the various embodiments of this invention. In such drawings:

FIG. 1 is a perspective view of cutting equipment for a metal strip according to an embodiment of the present invention;

FIG. 2 is a perspective view of the cutting equipment for a metal strip with a part of structure being hidden according to an embodiment of the present invention;

FIG. 3 a perspective view of the cutting equipment for a metal strip with a part of structure being hidden according to an embodiment of the present invention;

FIG. 4 a perspective view of the cutting equipment for a metal strip with a part of structure being hidden according to an embodiment of the present invention;

FIG. 5 is a perspective view of the fetching device according to an embodiment of the present invention;

FIG. 6 is an exploded view of FIG. 5;

FIG. 7 is a perspective view of the cutting device according to an embodiment of the present invention.

FIG. 8 is an exploded view of FIG. 7;

FIG. 9 is a perspective view of the support platform according to an embodiment of the present invention;

FIG. 10 is a perspective view of the driving device according to an embodiment of the present invention;

FIG. 11 illustrates the positional relationship between various cams and their corresponding structures according to an embodiment of the present invention; and

FIG. 12 is a perspective view of the feeding device according to an embodiment of the present invention.

### DETAILED DESCRIPTION OF ILLUSTRATED EMBODIMENTS

To further illustrate the technical content, structural features, objectives, and effects of the present invention, the following description is provided in conjunction with the drawings.

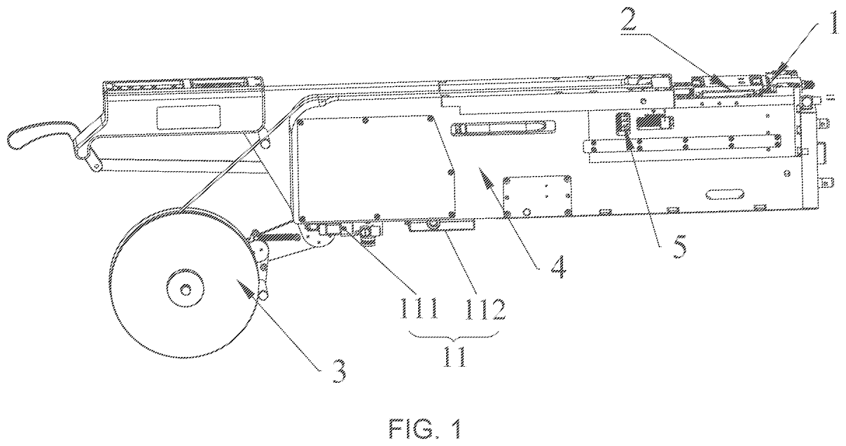

Referring to FIGS. 1 to 3, the present invention discloses cutting equipment for a metal strip, which includes a frame 4 and a feeding device 3, a fetching device 2, and a cutting device 1 mounted on the frame 4 respectively. The feeding device 3 is configured to load the strips, the fetching device 2 is configured to press the strip pulled from the feeding device 3, and the strip is conveyed to the cutting device 1. The cutting device 1 includes a first pressing mechanism 13, a support platform 12, and a vacuum generating device 11. The first pressing mechanism 13 is configured to press the strip, and the support platform 12 is provided with a through hole 121, which is connected to the vacuum generating device 11. When the strip covers the through hole 121, the vacuum generating device 11 is configured to extract the air inside the through hole 121 to position the strip on the support platform 12. The first pressing mechanism 13 and the support platform 12 are movable up and down respectively to create a height difference between a first strip section on the first pressing mechanism 13 and a second strip section on the support platform 12 for cutting.

Based on the above configurations, the present invention enables automated cutting of the strips and simplifies the mechanical structure of the device by using the vacuum generating device 11 and the through hole 121 instead of traditional pressing mechanisms. Meanwhile, the reliability of the cutting operation is improved to prevent the prolonged wear of the pressing mechanism from affecting the cutting effect.

It should be understood that multiple through holes 121 may be provided on the support platform 12, and each through hole 121 is located near the fetching device 2. At least one through hole 121 is positioned at the edge of the support platform 12 near the fetching device 2.

Referring to FIG. 1, specifically, the vacuum generating device 11 includes an electromagnetic valve 111 and a vacuum generator 112. The vacuum generator 112 is connected to the through hole 121 through a pipeline (not shown in the figure), and the electromagnetic valve 111 is connected to the vacuum generator 112 and configured to control the operation state of the vacuum generator 112, i.e., whether to extract the air inside the through hole 121.

Furthermore, the first pressing mechanism 13 is in close contact with the support platform 12. When the first pressing mechanism 13 and the support platform 12 create a height difference for cutting the strip, the cutting surface of the strip is formed between the first pressing mechanism 13 and the support platform 12, and the cutting surface is flat. Preferably, the height difference may be formed when the support platform 12 is higher than the first pressing mechanism 13.

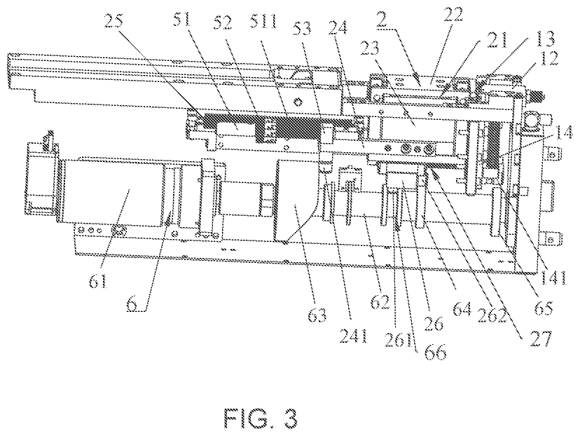

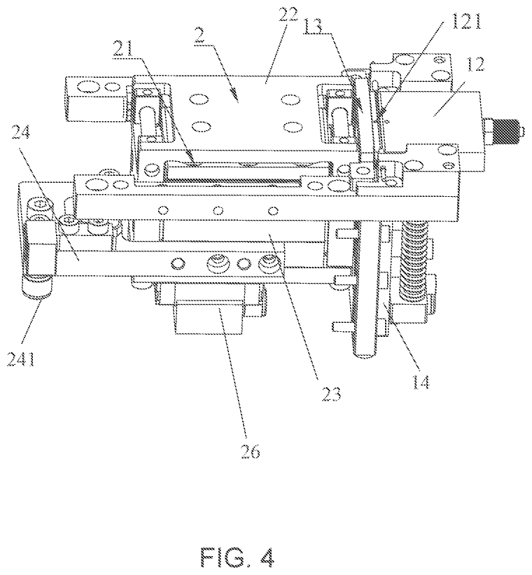

Referring to FIGS. 3 to 6, specifically, the fetching device 2 includes a second pressing mechanism 21 and a first moving mechanism. The second pressing mechanism 21 is provided with a pressing channel, which includes a first pressing surface and a second pressing surface which are mutually parallel. When the strip pulled from the feeding device 3 is located in the pressing channel, the second pressing mechanism 21 can close the pressing channel to bring the first pressing surface close to the second pressing surface so as to press the strip. The first moving mechanism is configured to drive the second pressing mechanism 21 to move and convey the pressed strip to the cutting device 1.

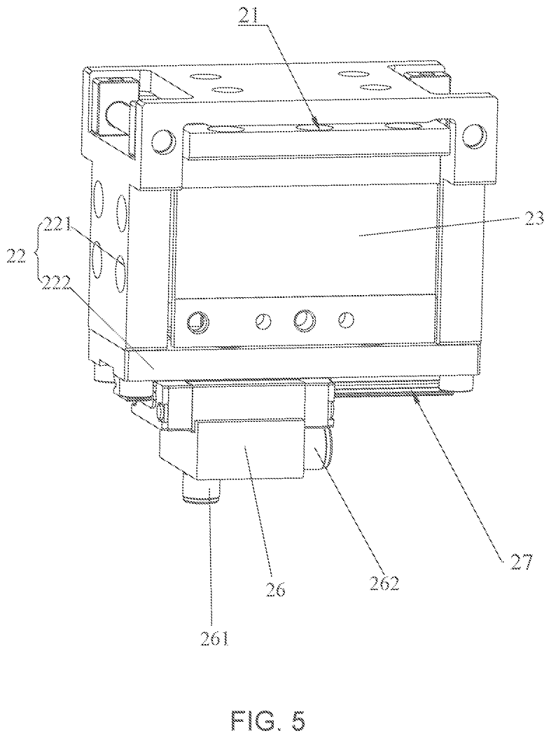

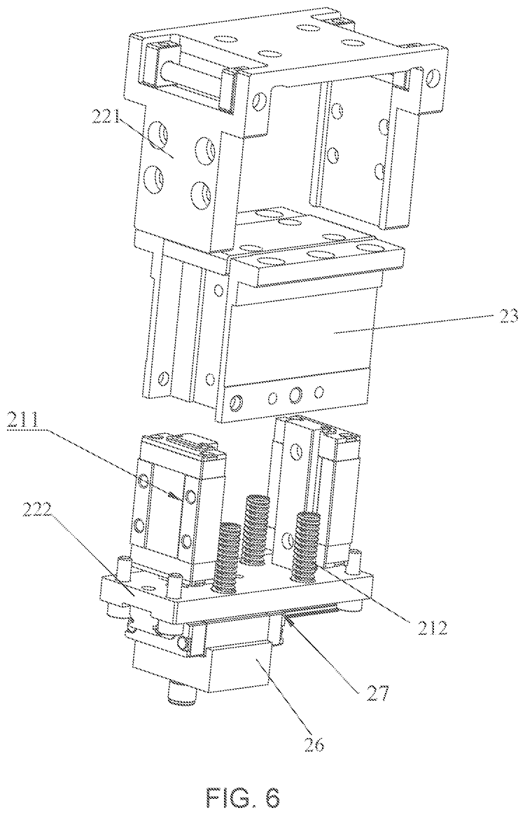

It should be understood that the length of the pressing channel should be greater than or equal to the length of each strip section entering to the cutting device 1 by the fetching device 2, so as to ensure that each strip section entering to the cutting device 1 has been pressed, therefore the strip conveyed to the cutting device 1 is always in a straight state. Referring to FIGS. 5 and 6, in some embodiments, the second pressing mechanism 21 includes a first pressing module 22 and a second pressing module 23. The first pressing module 22 includes a first supporting member 222 and a pressing member 221 connected to the first supporting member 222. The pressing member 221 can slide up and down and is connected to the second pressing module 23. The second pressing module 23 is connected to the first moving mechanism. The pressing member 221 is arranged opposite to the second pressing module 23 to form a pressing channel. The fetching device 2 further includes a second moving mechanism, which is configured to drive the first supporting member 222 to move up and down. With the up and down movement of the first supporting member 222, the pressing member 221 moves closer to or away from the second pressing module 23 to close or open the pressing channel.

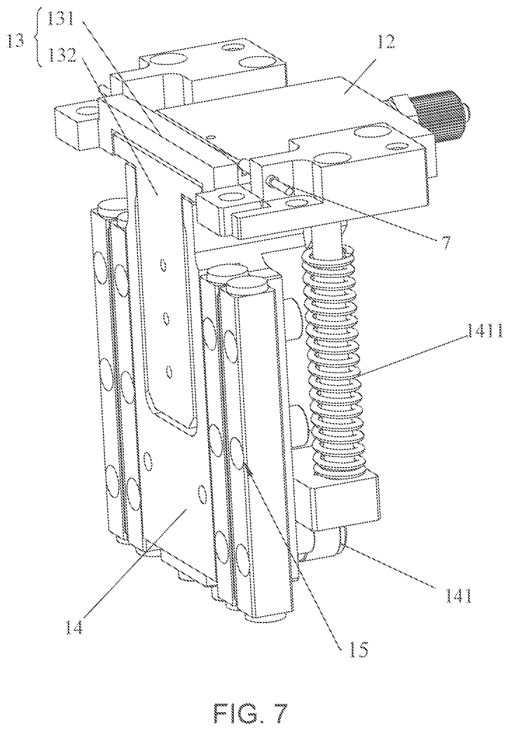

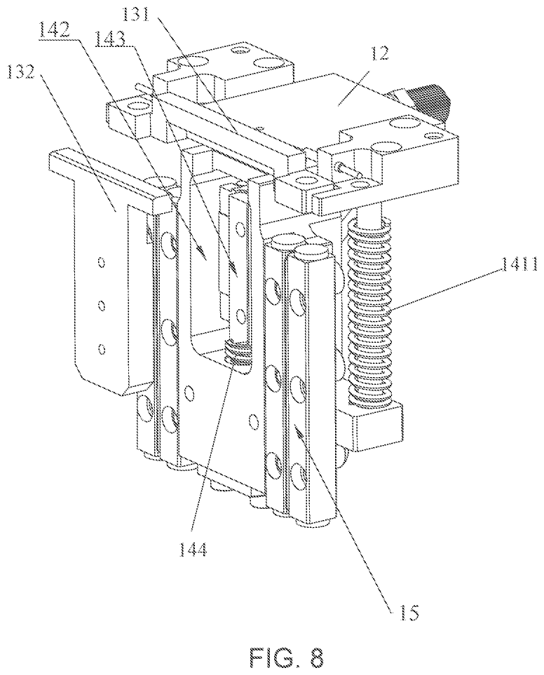

Referring to FIGS. 7 and 8, furthermore, the cutting device 1 includes a second supporting member 14 and a third moving mechanism connected to the second supporting member 14. The second supporting member 14 is vertically slidably connected to the frame 4. The first pressing mechanism 13 includes a third pressing module 131 and a fourth pressing module 132 arranged opposite to each other. The fourth pressing module 132 is movably connected to the second supporting member 14 and a first elastic member 144 is provided between the bottom of the fourth pressing module 132 and the second supporting member 14. The support platform 12 is connected to the second supporting member 14. The third moving mechanism can drive the second supporting member 14 to move up and down, to bring the fourth pressing module 132 close to or away from the third pressing module 131 so as to press or release the strip section between the third pressing module 131 and the fourth pressing module 132. During the upward movement of the second supporting member 14, the third pressing module 131 is configured to block the fourth pressing module 132, and compress the first elastic member 144. Under the driving of the second supporting member 14, the strip section positioned by the through hole 121 and the vacuum generating device 11 on the support platform 12 continues to be lifted for cutting.

Specifically, the second supporting member 14 is provided with an installation groove 142, and the side wall of the installation groove 142 is provided with a fourth sliding structure 143. The fourth pressing module 132 is movably connected to the side wall of the installation groove 142 through the fourth sliding structure 143. By setting the first elastic member 144 between the bottom of the second supporting member 14 and the fourth pressing module 132, when the second supporting member 14 drives the fourth pressing module 132 to rise and press the strip against the third feeding module 131, the second supporting member 14 can still continue to rise by compressing the first elastic member 144 to drive the support platform 12 to rise and exceed the height of the first pressing mechanism 13, thus causing a height difference between the strip section located on the first pressing mechanism 13 and the strip section located on the support platform 12 for cutting.

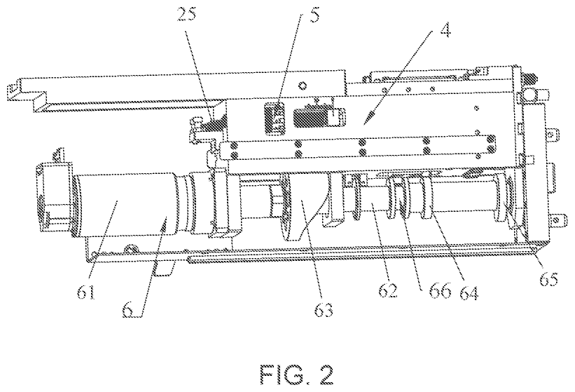

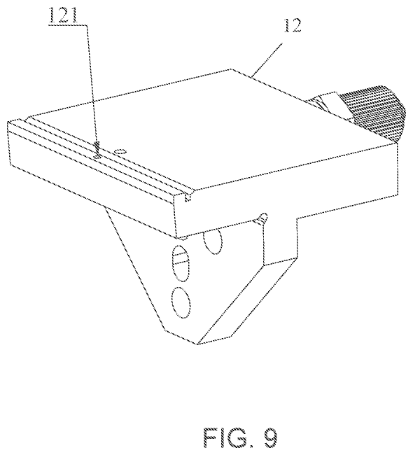

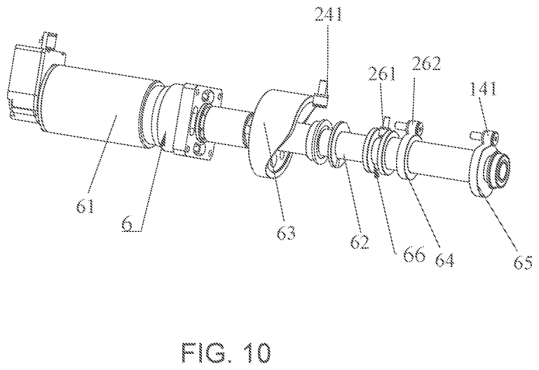

Referring to FIGS. 2 to 10, in some embodiments, the cutting equipment further includes a driving device 6. The driving device 6 includes a first cam 63. The first moving mechanism includes a second elastic member 25, a first sliding structure 27, and a first transmission structure. The second pressing mechanism 21 is movably arranged inside the frame 4 through the first sliding structure 27. The two ends of the second elastic member 25 are respectively connected to the first transmission structure and the frame 4 to make the first transmission structure tend to move away from the cutting device 1. The first transmission structure includes a first movable member 24, which is provided with a first sliding part 241. The first movable member 24 is connected to the second pressing mechanism 21, and the first sliding part 241 abuts against the first cam 63. The driving device 6 can drive the first cam 63 to rotate, under the rotation of the first cam 63, the first sliding part 241 slides along the first cam 63 to make the second pressing mechanism 21 laterally slide close to or away from the cutting device 1. Under the action of the second elastic member 25, the first sliding part 241 can slide along the edge of one surface of the first cam 63, which has a partially raised portion. When the first sliding part 241 slides to the raised portion, the second pressing mechanism 21 moves to the position close to the cutting device 1. When the first sliding part 241 slides to the flat portion, the second pressing mechanism 21 moves to the position away from the cutting device 1.

Referring to FIGS. 2 to 10, in some embodiments, the second moving mechanism includes a second transmission structure and a second sliding structure 211. The second transmission structure includes a second movable member 26, which is provided with a second sliding portion 261 and a third sliding portion 262. The second sliding structure 211 is positioned between the second pressing module 23 and the pressing member 221, and the pressing member 221 is connected to the second pressing module 23 and can slide up and down with the second sliding structure 211. The second movable member 26 and the bottom of the first supporting member 222 are connected through a first sliding structure 27. The driving device 6 includes a limiting groove 66 and a second cam 64. The second sliding portion 261 is located within the limiting groove 66, and the third sliding portion 262 abuts against the outer peripheral wall of the second cam 64. Under a rotation of the second cam 64, the third sliding portion 262 slides along the outer peripheral wall of the second cam 64, thereby causing the second movable member 26, the first supporting member 222, and the pressing member 221 to move up and down. By positioning the second sliding portion 261 within the limiting groove 66, the resistance between the second sliding portion 261 and the groove wall of the limiting groove 66 can be reduced during the rotation.

Referring to FIGS. 2 to 10, in some embodiments, the third moving mechanism includes a fourth sliding part 141 provided on the second supporting member 14 and a third sliding structure 15. The second supporting member 14 is vertically slidably connected to the frame 4 through the third sliding structure 15. The driving device 6 includes a third cam 65, and the fourth sliding part 141 abuts against the outer peripheral wall of the third cam 65. Under the rotation of the third cam 65, the fourth sliding part 141 can slide along the outer peripheral wall of the third cam 65 to drive the second supporting member 14 to move up and down.

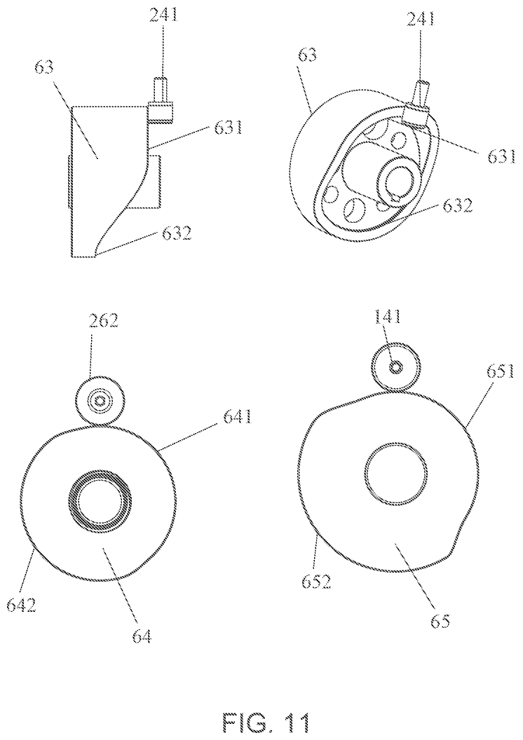

Referring to FIGS. 2 to 11, in some embodiments, the driving device 6 includes a driving motor 61, a rotating shaft 62 connected to the output end of the driving motor 61, and a first cam 63, a second cam 64, a third cam 65, and a limiting groove 66 respectively provided on the rotating shaft 62.

An edge of a surface of the first cam 63 includes a first portion 631 and a second portion 632 protruding from the surface. The outer peripheral wall of the second cam 64 includes a third portion 641 and a fourth portion 642, and a distance between the third portion 641 and a rotation center of the second cam 64 is smaller than a distance between the fourth portion 642 and the rotation center of the second cam 64. The outer peripheral wall of the third cam 65 includes a fifth portion 651 and a sixth portion 652, and a distance between the fifth portion 651 and a rotation center of the third cam 65 is smaller than a distance between the sixth portion 652 and the rotation center of the third cam 65.

When the first sliding part 241 slides from the first portion 632 to the second portion 631, the second pressing mechanism 21 moves from a position away from the cutting device 1 to a position close to the cutting device 1. When the first sliding part 241 slides from the second portion 631 to the first portion 632, the second pressing mechanism 21 moves from a position close to the cutting device 1 to a position away from the cutting device 1. When the third sliding part 262 slides from the third portion 641 to the fourth portion 642, the pressing member 221 and the first supporting member 222 move upward to open the pressing channel. When the third sliding part 262 slides from the fourth portion 642 to the third portion 641, the pressing member 221 and the first supporting member 222 move downward to close the pressing channel. When the fourth sliding part 141 slides from the fifth portion 651 to the sixth portion 652, the second supporting member 14 moves upward, causing the fourth pressing module 132 to move closer to the third pressing module 131 to press the strip, and creating a height difference between the first pressing mechanism 13 and the support platform 12. When the fourth sliding part 141 slides from the sixth portion 652 to the fifth portion 651, the second supporting member 14 moves downward, causing the fourth pressing module 132 to move away from the third pressing module 131 to release the strip.

When the first sliding part 241 abuts against the first portion 632, the third sliding part 262 abuts against the fourth portion 642, and the fourth sliding part 141 abuts against the sixth portion 652, the second pressing mechanism 21 is in a first position away from the cutting device 1, and the pressing channel is in an open state, at this time, the first pressing mechanism 13 presses the strip. The driving motor 61 continues to drive the first cam 63 to rotate, causing the first sliding part 241 to slide to the second portion 631, the second pressing mechanism 21 with the pressed strip moves to a second position close to the cutting device 1, and then the vacuum generation device extracts the air in the through hole to position the strip section on the support platform. The driving motor 61 continues to drive the third cam 65 to rotate, causing the fourth sliding part 141 to slide from the fifth portion 651 to the sixth portion 652, and the first pressing mechanism 13 presses the strip to form a height difference with the support platform 12 for cutting.

By coordinating the first cam 63, the second cam 64, and the third cam 65, the strip is cut efficiently. Only one driving motor 61 is used as the power source, which is beneficial for simplifying the device structure and reducing the device size. The cooperation of the first cam 63 and the second cam 64 can ensure consistent length of the strip fed into the cutting device 1, thereby guaranteeing consistent lengths of the cut pieces. By adjusting the cooperation relationship between the first cam 63 and the second cam 64, the length of the strip fed into the cutting device 1 can be adjusted. For example, the length of each strip fed into the cutting device 1 is the moving distance of the second pressing mechanism 21 moved to the second position. That's to say, the structure of the first cam 63 and the second cam 64 may be changed, for example, the first cam 63 may have multiple first portions 632 and second portions 631, and the second cam 64 may have multiple third portions 641 and the fourth portions 642. In such a way, multiple feedings of the strip within one cycle may be achieved, thereby improving the cutting efficiency.

Referring to FIGS. 6 and 7, the device further includes a third elastic member 212 and a fourth elastic member 1411. The third elastic member 212 is located between the bottom of the first pressing module 22 and the first supporting member 222, so as to provide a downward force to the first supporting member 222, thereby causing the third sliding part 262 to be pressed against the second cam 64 due to the elastic force of the third elastic member 212 and the force of gravity. The fourth elastic member 1411 is located between the frame 4 and the second supporting member 14, so as to provide a downward force to the second supporting member 14, thereby causing the fourth sliding part 141 to be pressed against the outer peripheral wall of the third cam 65.

Referring to FIGS. 1 to 3, in some embodiments, the cutting equipment further includes a length adjustment device 5. The length adjustment device 5 includes a fixing member 53, a threaded pillar 51, and an adjusting nut 52. The fixing member 53 is connected to the first movable member 24. The threaded pillar 51 has a threaded portion 511, and the adjusting nut 52 is screwed into the threaded portion 511. The threaded pillar 51 is located inside the side wall of the frame 4, with one end of the threaded pillar 51 facing the fixing member 53. The side wall of the frame 4 corresponding to the position of the adjusting nut 52 is provided with an opening. By rotating the adjusting nut 52, the length of the threaded pillar 51 between the adjusting nut 52 and the fixing member 53 can be adjusted. Under the pulling action of the second elastic member 25, the threaded pillar 51 blocks the fixing member 53, so as to prevent the first movable member 24 from moving further away from the cutting device 1. Due to presence of the length adjustment device 5, the adjustment of the length of the strip fed into the cutting device 1 is allowed.

In particular, the adjustment nut 52 is provided with a scale to facilitate the user to judge the length of the adjustment.

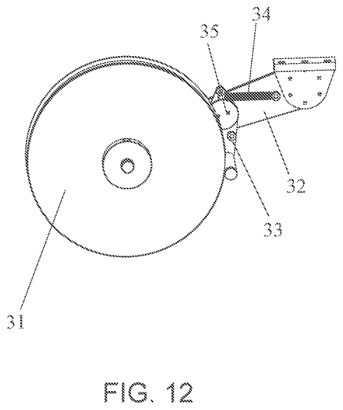

Referring to FIGS. 1 and 12, in particular, the feeding device 3 includes a connecting member 32, a reel 31 rotatably connected on the connecting member 32, and a braking structure. The connecting member 32 is connected to the frame 4, and the reel 31 is wound with the strip to be cut. When the fetching device 2 pulls the strip, the reel 31 rotates to release the strip. The braking structure includes a rotating shaft 35, a braking member 33, and a braking elastic member 34. The braking elastic member 34 is connected to the braking member 33, and the braking member 33 is rotatably connected to the connecting member 32 through the rotating shaft 35. The braking elastic member 34 applies a force on one end of the braking member 33 to rotate around the rotating shaft 35, and the other end of the braking member 33 abuts against the reel 31, and the reel 31 limits a rotation tendency of the braking member 33. The reel 31 is contacted with the braking member 33 when rotating, to generate a resistance to prevent the reel 31 from rotating excessively and feeding out excess strip.

Referring to FIG. 7, in some embodiments, the device further includes a fiber optic sensor 7. A transmitting end and a receiving end of the fiber optic sensor 7 may be respectively arranged on both sides of the frame 4, and the strip that is cut down will block the space between the transmitting end and the receiving end of the fiber optic sensor 7. After the cutting device 1 finishes the cutting, the strip will be removed. Such a behavior will be detected by the fiber optic sensor 7, thereby sending out control information.

The first sliding structure 27, the second sliding structure 211, the third sliding structure 15, and the fourth sliding structure 143 mentioned in the invention may all refer to cooperation structures of slide rails and sliders, or other mutually sliding structures, such as a cross roller, which are not limited here.

The disclosed embodiments are only preferred embodiments of the present invention and should not to limit the scope of the invention. Equivalent changes made within the scope of the claims of the present invention are still covered by the invention.

What is claimed is:

1. Cutting equipment for a metal strip, comprising a frame, and a feeding device, a fetching device and a cutting device mounted on the frame respectively,
wherein the feeding device is configured to providing a strip;
the fetching device is configured to press the strip pulled from the feeding device and convey the strip to the cutting device; and
the cutting device comprises a first pressing mechanism, a support platform, and a vacuum generating device, the first pressing mechanism is configured to press the strip, the support platform is provided with a through hole which is connected to the vacuum generating device; when the through hole is covered by the strip, the vacuum generating device is configured to extract air in the through hole so as to position the strip on the support platform, the first pressing mechanism and the support platform are movable up and down respectively to form a height difference between a first strip section located on the first pressing mechanism and a second strip section located on the support platform for cutting.

2. The cutting equipment according to claim 1, wherein the fetching device comprises a second pressing mechanism and a first moving mechanism, the second pressing mechanism is provided with a pressing channel, the pressing channel comprises a first pressing surface and a second pressing surface which are mutually parallel, when the strip pulled from the feeding device is located in the pressing channel, the second pressing mechanism is configured to close the pressing channel to bring the first pressing surface close to the second pressing surface so as to press the strip, and the first moving mechanism is configured to drive the second pressing mechanism to move the strip pressed to the cutting device.

3. The cutting equipment according to claim 2, wherein the second pressing mechanism comprises a first pressing module and a second pressing module, the first pressing module comprises a first supporting member and a pressing member connected to the first supporting member, the pressing member is slidably connected to the second pressing module, the second pressing module is connected to the first moving mechanism, the pressing member is oppositely arranged with the second pressing module to form the pressing channel, the fetching device further comprises a second moving mechanism which is configured to drive the first supporting member to move up and down, under an action of an upward and downward movement of the first supporting member, the pressing member moves close or away from the second pressing module to close or open the pressing channel.

4. The cutting equipment according to claim 3, wherein the cutting device further comprises a second supporting member and a third moving mechanism connected to the second supporting member, the second supporting member is slidably connected to the frame, the first pressing mechanism comprises a third pressing module and a fourth pressing module arranged opposite to each other, the fourth pressing module is movably connected to the second supporting member, a first elastic member is provided between a bottom of the fourth pressing module and the second supporting member, and the support platform is connected to the second supporting member;
the third moving mechanism is configured to drive the second supporting member to move up and down to bring the fourth pressing module close to or away from the third pressing module to press or release a strip section located between the third pressing module and the fourth pressing module;
during an upward movement of the third supporting member, the third pressing module is configured to block the fourth pressing module and compress the first elastic member, and another strip section positioned by the through hole and the vacuum generating device on the support platform continues to be lifted for cutting under a driving of the third supporting member.

5. The cutting equipment according to claim 4, further comprising a driving device, wherein the driving device comprises a first cam, the first moving mechanism comprises a second elastic member, a first sliding structure, and a first transmission structure, the second pressing mechanism is be movably arranged in the frame through the first sliding structure, two ends of the second elastic member are respectively connected to the first transmission structure and the frame to make the first transmission structure tend to move away from the cutting device, the first transmission structure comprises a first movable member, the first movable member is provided with a first sliding part, the first movable member is connected to the second pressing mechanism, the first sliding part abuts against the first cam, the driving device is configured to drive the first cam to rotate, under a rotation of the first cam, the first sliding part slides along the first cam to make the second pressing mechanism laterally slide to close or move away from the cutting device.

6. The cutting equipment according to claim 5, wherein the second moving mechanism comprises a second transmission structure and a second sliding structure, the second transmission structure comprises a second movable member, and the second movable member is provided with a second sliding part and a third sliding part, and the second sliding structure is arranged between the second pressing module and the pressing member, and the pressing member is slidably connected to the second pressing module up and down through the second sliding structure;
the second movable member is connected to a bottom of the first supporting member through the first sliding structure, and the driving device comprises a limit groove and a second cam, the second sliding part is located in the limit groove, and the third sliding part abuts against an outer peripheral wall of the second cam; when the second cam is driven to rotate, the third sliding part slides along the outer peripheral wall of the second cam to drive the second movable member, the first supporting member, and the pressing member to move up and down.

7. The cutting equipment according to claim 6, wherein the third moving mechanism comprises a fourth sliding part and a third sliding structure provided on the second supporting member, the second supporting member is slidably connected to the frame up and down through the third sliding structure, the driving device comprises a third cam, and the fourth sliding part abuts against an outer peripheral wall of the third cam; when the third cam is driven to rotate, the fourth sliding part slides along the outer peripheral wall of the third cam to drive the second supporting member to move up and down.

8. The cutting equipment according to claim 7, wherein the driving device comprises a drive motor, a rotating shaft connected to an output end of the drive motor, and a first cam, a second cam and a third cam respectively provided on the rotating shaft, and the limit groove is provided on the rotating shaft;
an edge of a surface of the first cam comprises a first portion and a second portion protruding from the surface; the outer peripheral wall of the second cam comprises a third portion and a fourth portion, and a distance between the third portion and a rotation center of the second cam is smaller than a distance between the fourth portion and the rotation center of the second cam; the outer peripheral wall of the third cam comprises a fifth portion and a sixth portion, and a distance between the fifth portion and a rotation center of the third cam is smaller than a distance between the sixth portion and the rotation center of the third cam;
when the first sliding part abuts against the first portion, the third sliding part abuts against the fourth portion, and the fourth sliding part abuts against the sixth portion, the second pressing mechanism is in a first position away from the cutting device, and the pressing channel is in an open state, and the first pressing mechanism is configured to press the strip; when the driving motor drives the second cam and the third cam to rotate, the third sliding part slides to the third portion, and the fourth sliding part slides to the fifth portion, the pressing channel is in a closed state, and the first pressing mechanism is configured to release the strip; the driving motor continues to drive the first cam to rotate, causing the first sliding part to slide to the second portion, the second pressing mechanism moves to a second position close to the cutting device, and the vacuum generation device is configured to extract the air in the through hole so as to position the strip section on the support platform; the driving motor continues to drive the third cam to rotate, causing the fourth sliding part to slide from the fifth portion to the sixth portion, and the first pressing mechanism is configured to press the strip to form a height difference with the support platform for cutting.

9. The cutting equipment according to claim 5, further comprising a length adjustment device, wherein the length adjustment device comprises a fixing member, a threaded pillar, and an adjusting nut, the fixing member is connected to the first movable member, the threaded pillar comprises a threaded portion, the adjusting nut is screwed into the threaded portion, the threaded pillar is located inside a side wall of the frame and one end of the threaded pillar faces the fixing member, the side wall of the frame corresponding to a position of the adjusting nut is provided with an opening, the adjusting nut is rotatable to adjust a length of the threaded pillar between the adjusting nut and the fixing member; under a pulling action of the second elastic member, the threaded pillar is configured to block the fixing member to prevent the first movable member from moving further away from the cutting device.

10. The cutting equipment according to claim 1, wherein the feeding device comprises a connecting member, a reel rotatably connected to the connecting member, and a braking structure, the connecting member is connected to the frame, the reel is wound with the strip to be cut, and the braking structure comprises a rotating shaft, a braking member, and a braking elastic member, the braking elastic member is connected to the braking member, the braking member is rotatably connected to the connecting member through the rotating shaft, the braking elastic member is configured to apply a force to one end of the braking member to rotate around the rotating shaft, and another end of the braking member abuts against the reel, and the reel is configured to limit a rotation tendency of the braking member.
